(19) United States
(12) Patent Application Publication
(10) Pub. No.: US 2025/0251028 A1
(43) Pub. Date: Aug. 7, 2025

(54) ACTIVE-PASSIVE HYBRID CONTROL SYSTEM FOR ROTATIONAL TORQUE

(71) Applicant: SHENYANG UNIVERSITY OF TECHNOLOGY, Shenyang (CN)

(72) Inventor: Chunwei ZHANG, Shenyang (CN)

(21) Appl. No.: 19/051,402

(22) Filed: Feb. 12, 2025

Related U.S. Application Data
(63) Continuation of application No. PCT/CN2023/083707, filed on Mar. 24, 2023.

(30) Foreign Application Priority Data
Aug. 15, 2022 (CN) 202210976260.7

(51) Int. Cl. F16F 7/10

(52) U.S. Cl. CPC F16F 7/1005; F16F 2222/08; F16F 2230/18; F16F 2236/08

(57) ABSTRACT

An active-passive hybrid control system for rotational torque includes a first rotating shaft, an elastic reset member, a first rotating member, a first motor, a second rotating member, a sensor and a controller. The first rotating shaft is rotatably arranged on a to-be-controlled object. The elastic reset member is sleevedly arranged on the first rotating shaft. The first rotating member is arranged on the first rotating shaft. A first end of the elastic reset member is connected to the to-be-controlled object, and a second end of the elastic reset member is connected to the first rotating member. The first motor is provided on a side of the first rotating member away from the first rotating shaft. The second rotating member is arranged on the first motor. The controller is connected to the sensor and the first motor.

### CROSS-REFERENCE TO RELATED APPLICATIONS

This application is a continuation of International Patent Application No. PCT/CN2023/083707, filed on Mar. 24, 2023, which claims the benefit of priority from Chinese Patent Application No. 202210976260.7, filed on Aug. 15, 2022. The content of the aforementioned application, including any intervening amendments thereto, is incorporated herein by reference in its entirety.

### TECHNICAL FIELD

This application relates to bridge engineering, and more specifically to an active-passive hybrid control system for rotational torque.

### BACKGROUND

In the prior art, when a train travels on a bridge, track irregularities on the bridge deck will cause the train to vibrate. The vibrating train, in turn, exerts reactive forces on the track. Prolonged exposure to such conditions will lead to track deformation. As the track deformation increases, the vibration of the train acting on the track intensifies, thereby indirectly amplifying the vibration of the bridge. In severe cases, this may result in bridge collapse.

To address these issues, passive control methods such as dampers are typically employed for bridge vibration control. However, the damper can only output linear control forces, which means that it can only mitigate horizontal and vertical vibrations of the bridge and is ineffective against torsional vibrations. Additionally, the damper is also struggled with the following limitations. (1) The dampers have a limited tensile strength, and thus are prone to fracture during resonance between the train and the bridge. (2) The damping fluid in the dampers tends to overheat and emulsify under high-frequency reciprocating motion, leading to unstable control performance. Furthermore, due to the coupling effect between displacement and swing angle in tuned mass dampers, they cannot suppress vibration modes with rotational characteristics, rendering them ineffective in controlling bridge torsional vibrations. (3) When controlling torsional vibrations, the linear control force of dampers may exhibit chaotic phenomena, resulting in control effects varied under different excitation frequencies. Notably, under certain frequencies, tuned dampers not only fail to suppress bridge vibrations but may even exacerbate the bridge vibrations, thereby failing to achieve the intended control effects.

### SUMMARY

An objective of the present disclosure is to provide an active-passive hybrid control system for rotational torque, aiming to resolve the technical issue in the prior art where dampers fail to effectively address torsional vibrations in bridges, leading to poor bridge stability.

Technical solutions of the present disclosure are described below.

An active-passive hybrid control system for rotational torque, comprising:
a first rotating shaft;
an elastic reset member;
a first rotating member;
a first motor;
a second rotating member;
a sensor; and
a controller;
wherein the first rotating shaft is rotatably arranged on a to-be-controlled object; the elastic reset member is sleevedly arranged on the first rotating shaft; the first rotating member is arranged on the first rotating shaft; and a first end of the elastic reset member is connected to the to-be-controlled object, and a second end of the elastic reset member is connected to the first rotating member;
the first motor is provided on a side of the first rotating member away from the first rotating shaft; the second rotating member is arranged on the first motor; the controller is connected to the sensor and the first motor; the first rotating member is configured to rotate in a direction opposite to a torsion direction of the to-be-controlled object under an action of the to-be-controlled object; the sensor is configured to detect an torsion angle of the to-be-controlled object and transmit the torsion angle to the controller; the controller is configured to process the torsion angle to generate a processing result, and output a corresponding control command to the first motor based the a processing result, thereby driving the second rotating member to rotate to accelerate a rotation of the first rotating member; and
the first rotating member comprises a first rotating plate and a first flange extending radially from an edge of the first rotating plate toward the first motor, and the first flange is annular; the second end of the elastic reset member is connected to the first rotating plate; the first rotating plate is arranged on the first rotating shaft; the first motor is provided on the side of the first rotating plate away from the first rotating shaft; and
the second rotating member comprises a second rotating plate and a second motor; the second rotating plate is arranged on the first motor; the second motor is provided on a side of the second rotating plate away from the first motor; the second motor is in transmission connection with an inner wall of the first flange; and the controller is further configured to control the second motor to accelerate a rotation of the first flange based on the processing result, thereby making the first flange drive the first rotating plate to rotate.

In some embodiments, the active-passive hybrid control system further comprises a transmission assembly, wherein the second motor and the first flange are in transmission connection through the transmission assembly.

In some embodiments, the transmission assembly comprises a gear; the second motor is provided with a second rotating shaft; the gear is sleevedly arranged on the second rotating shaft; the inner wall of the first flange is provided with a toothed ring; and the gear is engaged with the first flange through the toothed ring for transmission.

In some embodiments, a plurality of second motors and a plurality of gears are provided; the plurality of second motors are arranged on the side of the second rotating plate away from the first motor; and the plurality of gears are arranged on second rotating shafts of the plurality of second motors in one-to-one correspondence.

In some embodiments, the active-passive hybrid control system further comprises a base assembly, wherein the base assembly is configured to be mounted within the to-be-controlled object; the first rotating shaft is rotatably mounted on the base assembly; and the first end of the elastic reset member is connected to the base assembly.

In some embodiments, the base assembly comprises a mounting seat and a connecting arm arranged on the mounting seat; an end of the connecting arm away from the mounting seat is connected to an inner wall of the to-be-controlled object; the first rotating shaft is rotatably arranged on the mounting seat; and the first end of the elastic reset member is connected to the mounting seat.

In some embodiments, the mounting seat comprises a mounting plate and a second flange extending radially from an edge of the mounting plate toward the first rotating shaft, and the second flange is annular; the first rotating shaft is rotatably arranged on the mounting plate; the first end of the elastic reset member is connected to the mounting plate; the connecting arm is provided on an outer wall of the second flange; and an outer wall of the first flange is rotatable along an inner wall of the second flange.

In some embodiments, the active-passive hybrid control system further comprises a rolling element, wherein the rolling element is provided between the first flange and the second flange; and the outer wall of the first flange is provided with a first raceway; the inner wall of the second flange is provided with a second raceway corresponding to the first raceway; the rolling element is rollable within a cavity formed by the first raceway and the second raceway, so as to enable the outer wall of the first flange to rotate along the inner wall of the second flange.

In some embodiments, the active-passive hybrid control system further comprises a holder, wherein a plurality of rolling elements are provided; the plurality of rolling elements are rotatably arranged spaced apart on the holder; and the first flange is configured to drive the plurality of rolling elements to rotate, so as to drive the holder to rotate.

Compared with the prior art, the present disclosure at least has the following beneficial effects.

The first rotating member of this application is rotatable relative to the to-be-controlled object via the first rotating shaft. Under the action of the to-be-controlled object, the first rotating member rotates in a direction opposite to the torsion direction of the to-be-controlled object. This generates a torque to counteract the torsional vibration of the to-be-controlled object, which is transmitted to the to-be-controlled object through the elastic reset member, thereby suppressing torsional vibrations and enhancing the stability of the to-be-controlled object. As such, the active-passive hybrid control system for rotational torque can achieve energy-saving effects. In addition, the sensor detects the torsion angle of the to-be-controlled object and transmits it to the controller. The controller processes the received torsion angle and outputs corresponding control commands to the first motor to drive the second rotating member to rotate. In this case, the second rotating member generates a torque, which is transmitted to the first rotating member via the first motor, thereby accelerating the rotation of the first rotating member. As a result, the first rotating member rapidly generates a torque to counteract the torsional vibration of the to-be-controlled object. The torque generated by the first rotating member is further transmitted to the to-be-controlled object through the elastic reset member, enabling rapid suppression of torsional vibration of the to-be-controlled object. This significantly improves the precision and real-time responsiveness of the torque generation of the active-passive hybrid control system.

### BRIEF DESCRIPTION OF THE DRAWINGS

To more clearly illustrate the technical solutions in the embodiments of the present disclosure or in the prior art, the drawings required for describing the embodiments or the prior art will be briefly introduced. Obviously, the drawings in the following description are merely some embodiments of the present disclosure. For one of ordinary skill in the art, other drawings may be derived from these illustrations without creative effort.

FIG. 1 is a schematic diagram of an active-passive hybrid control system for rotational torque according to an embodiment of the present disclosure;

FIG. 2 is a sectional view of the active-passive hybrid control system according to an embodiment of the present disclosure; and

FIG. 3 is a partial structural diagram of the active-passive hybrid control system according to an embodiment of the present disclosure.

In the drawings:

100, active-passive hybrid control system for rotational torque; 1, elastic reset member; 2, first rotating member; 21, first rotating plate; 22, first flange; 3, first motor; 4, second rotating member; 41, second rotating plate; 42, second motor; 421, second rotating shaft; 5, sensor; 6, controller; 7, to-be-controlled object; 8, transmission assembly; 81, gear; 9, base assembly; 91, mounting seat; 911, mounting plate; 912, second flange; 92, connecting arm; 10, rolling element; 11, holder; 12, first fixing member; and 13, second fixing member.

### DETAILED DESCRIPTION OF EMBODIMENTS

The technical solutions in the embodiments of the present disclosure will be clearly and completely described with reference to the accompanying drawings. It should be understood that described below are merely some embodiments of the present disclosure. All other embodiments obtained by one of ordinary skill in the art based on the embodiments provided herein without making creative efforts shall fall within the scope of the present disclosure.

It should be noted that all directional indications used herein (such as up, down, left, right, front, back, etc.) are only used to explain the relative positional relationships and movements between components under a specific orientation (as shown in the drawings). If the specific orientation changes, these directional indications shall be adjusted accordingly.

Furthermore, as used herein, the terms such as “first” and “second” are merely for illustrative purposes and shall not be construed as indicating or implying relative importance, nor implicitly specifying the quantity of technical features. Thus, features defined by “first” or “second” may explicitly or implicitly include at least one such feature. The term “and/or” covers three scenarios. For example, the term “A and/or B” includes a solution A, a solution B, and a solution including A and B. Additionally, technical solutions across different embodiments may be combined, provided such combinations can be reasonably achieved by those skilled in the art. Combinations resulting in contradictions or technical impossibilities shall be deemed non-existent and excluded from the scope of protection claimed by this disclosure.

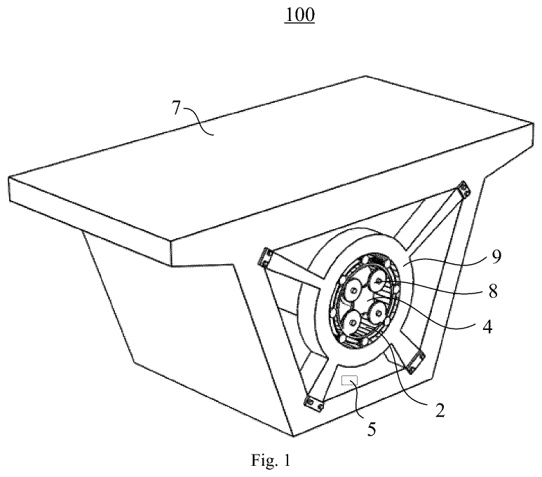

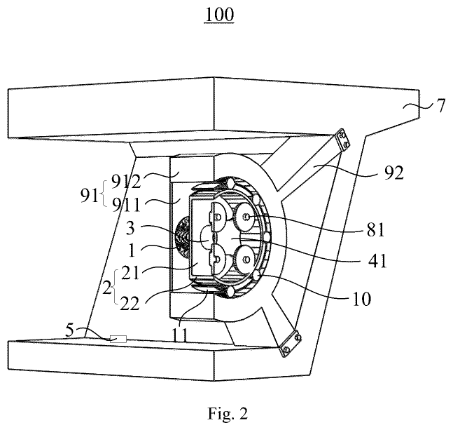

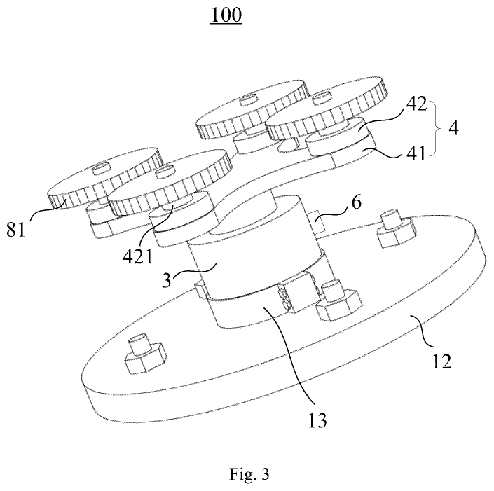

As shown in FIGS. 1-3, an active-passive hybrid control system 100 for rotational torque is provided, which includes a first rotating shaft, an elastic reset member 1, a first rotating member 2, a first motor 3, a second rotating member 4, a sensor 5 and a controller 6. The first rotating shaft is rotatably arranged on a to-be-controlled object 7. The elastic reset member 1 is sleevedly arranged on the first rotating shaft. The first rotating member 2 is arranged on the first rotating shaft. A first end of the elastic reset member 1 is connected to the to-be-controlled object 7, and a second end of the elastic reset member 1 is connected to the first rotating member 2. The first motor 3 is provided on a side of the first rotating member 2 away from the first rotating shaft. The second rotating member 4 is arranged on the first motor 3. The controller 6 is connected to the sensor 5 and the first motor 3. The first rotating member 2 is configured to rotate in a direction opposite to a torsion direction of the to-be-controlled object 7 under an action of the to-be-controlled object 7. The sensor 5 is configured to detect a torsion angle of the to-be-controlled object 7 and transmit the torsion angle to the controller 6. The controller 6 is configured to process the torsion angle to generate a processing result, and output a control command to the first motor 3 based on the processing result, thereby driving the second rotating member 4 to rotate to accelerate a rotation of the first rotating member 2.

The first rotating member 2 of this application is rotatable relative to the to-be-controlled object 7 via the first rotating shaft. Under the action of the to-be-controlled object 7, the first rotating member 2 rotates in a direction opposite to the torsion direction of the to-be-controlled object 7. This generates a torque to counteract the torsional vibration of the to-be-controlled object 7, which is transmitted to the to-be-controlled object 7 through the elastic reset member 1, thereby suppressing torsional vibrations and enhancing the stability of the to-be-controlled object 7. As such, the active-passive hybrid control system 100 for rotational torque can achieve energy-saving effects. In addition, the sensor 5 detects the torsion angle of the to-be-controlled object 7 and transmits it to the controller 6. The controller 6 processes the received torsion angle and outputs corresponding control commands to the first motor 3 to drive the second rotating member 4 to rotate. In this case, the second rotating member 4 generates a torque, which is transmitted to the first rotating member 3 via the first motor, thereby accelerating the rotation of the first rotating member 2. As a result, the first rotating member 2 rapidly generates a torque to counteract the torsional vibration of the to-be-controlled object 7. The torque generated by the first rotating member 2 is further transmitted to the to-be-controlled object 7 through the elastic reset member 1, enabling rapid suppression of torsional vibration of the to-be-controlled object 7. This significantly improves the precision and real-time responsiveness of the torque generation of the active-passive hybrid control system 100.

In this embodiment, the elastic reset member 1 is a torsion spring.

In this embodiment, the first motor 3 is a torque motor, which can generate a substantial torque.

In this embodiment, the sensor 5 is installed on the to-be-controlled object 7, and the controller 6 is mounted on the first motor 3.

In this embodiment, the to-be-controlled object 7 is a bridge.

The active-passive hybrid control system 100 further includes a bearing, which is provided on the to-be-controlled object 7. The first rotating shaft is connected to the bearing, enabling the first rotating shaft to be rotatably mounted on the to-be-controlled object 7.

The first rotating member 2 includes a first rotating plate 21 and a first flange 22 extending radially from an edge of the first rotating plate 21 toward the first motor 3, and the first flange 22 is annular. The second end of the elastic reset member 1 is connected to the first rotating plate 21. The first rotating plate 21 is arranged on the first rotating shaft. The first motor 3 is provided on the side of the first rotating plate 21 away from the first rotating shaft. The second rotating member 4 includes a second rotating plate 41 and a second motor 42. The second rotating plate 41 is arranged on the first motor 3. The second motor 42 is provided on a side of the second rotating plate 41 away from the first motor 3. The second motor 42 is in transmission connection with an inner wall of the first flange 22. The controller 6 is further configured to control the second motor 42 to accelerate a rotation of the first flange 22 based on the processing result, thereby making the first flange 22 to drive the first rotating plate 21 to rotate to rapidly generate a torque to counteract the torsional vibration of the to-be-controlled object 7. This significantly improves the real-time responsiveness of the torque generation of the active-passive hybrid control system 100.

In this embodiment, the second motor 42 is a high-speed motor, which has a rapid rotational speed. It should be noted that a “high-speed motor” refers to a motor with a rotational speed exceeding 10,000 r/min.

The active-passive hybrid control system 100 further includes a transmission assembly 8. The second motor 42 and the first flange 22 are in transmission connection through the transmission assembly 8. When the transmission assembly 8 is damaged, it only requires to replace the damaged transmission assembly 8, rather than the second motor 42, thereby reducing the replacement cost of the active-passive hybrid control system 100.

The transmission assembly 8 includes a gear 81. The second motor 42 is provided with a second rotating shaft 421. The gear 81 is sleevedly arranged on the second rotating shaft 421. The inner wall of the first flange 22 is provided with a ring of gear teeth. The gear 81 and the first flange 22 are in a meshed transmission connection.

The number of the second motor 42 and the number of the gear 81 are both multiple. The multiple second motors 42 are arranged on the side of the second rotating plate 41 away from the first motor 3. The multiple gears 81 are arranged on the multiple second rotating shafts 421 in one-to-one correspondence. Through the collaboration of multiple second motors 42 and multiple gears 81, the rotation of the first rotating member 2 can be accelerated. This enables the first rotating member 2 to rapidly generate torque that counteracts the torsional vibration of the to-be-controlled object 7, thereby further improving the real-time performance of the active-passive hybrid control system 100 in generating torque.

The multiple second motors 42 are uniformly arranged on the side of the second rotating plate 41 facing away from the first motor 3.

The numbers of the second motors 42 and the gears 81 are both four.

The active-passive hybrid control system 100 further includes a base assembly 9. The base assembly 9 is configured to be mounted within the to-be-controlled object 7. The first rotating shaft is rotatably mounted on the base assembly 9. The first end of the elastic reset member 1 is connected to the base assembly 9. The base assembly 9 is installed within the to-be-controlled object 7, enabling the torque generated by the first rotating member 2 to be transmitted into the to-be-controlled object 7 sequentially through the elastic reset member 1 and the base assembly 9. This ensures that the torque produced by the first rotating member 2 can more effectively counteract the torsional vibration generated by the to-be-controlled object 7, thereby enhancing the stability of the to-be-controlled object 7.

The base assembly 9 includes a mounting seat 91 and a connecting arm 92 arranged on the mounting seat 91. An end of the connecting arm 92 away from the mounting seat 91 is connected to an inner wall of the to-be-controlled object 7. The first rotating shaft is rotatably arranged on the mounting seat 91. The first end of the elastic reset member 1 is connected to the mounting seat 91.

In this embodiment, the connecting arm 92 is in a flat-strip shape. Compared to a plate-shaped connecting arm with a larger area, this configuration reduces costs and decreases the weight of the active-passive hybrid control system 100, thereby lowering the load imposed by the system on the to-be-controlled object 7 and further enhancing the safety of the to-be-controlled object 7.

The number of the connecting arm 92 is multiple. The multiple connecting arms 92 are arranged spaced apart on the mounting seat 91. The end of each connecting arm 92 away from the mounting seat 91 is connected to the inner wall of the to-be-controlled object 7. The use of the multiple connecting arms 92 not only enhances the connection reliability between the mounting seat 91 and the to-be-controlled object 7 but also distributes the torque generated by the first rotating member 2 across different parts of the to-be-controlled object 7. This ensures that the torque produced by the first rotating member 2 more effectively counteracts the torsional vibration generated by the to-be-controlled object 7, thereby improving the stability of the to-be-controlled object 7.

The number of the connecting arms 92 is four.

The mounting seat 91 includes a mounting plate 911 and a second flange 912 extending radially from an edge of the mounting plate 911 toward the first rotating shaft, and the second flange 912 is annular. The first rotating shaft is rotatably arranged on the mounting plate 911. The first end of the elastic reset member 1 is connected to the mounting plate 911. The connecting arm 92 is provided on an outer wall of the second flange 912. An outer wall of the first flange 22 is rotatable along an inner wall of the second flange 912. The first motor 3 drives the first rotating plate 21 to rotate, making the first flange 22 to rotate around the inner wall of the second flange 912. This allows the torque generated by the first flange 22 to be transmitted to the to-be-controlled object 7 sequentially through the second flange 912, the mounting seat 91 and the connecting arms 92. As a result, the torque produced by the first rotating member 2 can rapidly counteract the torsional vibration of the to-be-controlled object 7, thereby further enhancing the real-time performance of the active-passive hybrid control system 100 in generating torque.

The active-passive hybrid control system 100 further includes a rolling element 10. The rolling element 10 is provided between the first flange 22 and the second flange 912. The outer wall of the first flange 22 is provided with a first raceway. The inner wall of the second flange 912 is provided with a second raceway corresponding to the first raceway. The rolling element 10 is rollable within a cavity formed by the first raceway and the second raceway, enabling the outer wall of the first flange 22 to rotate along the inner wall of the second flange 912. The first raceway and second raceway are configured to prevent the rolling element 10 from dislodging during rolling between the first flange 22 and the second flange 912. This ensures that the rolling element 10 reliably rolls within the cavity jointly formed by the first raceway and second raceway, thereby improving the rolling reliability of the rolling element 10.

In this embodiment, the rolling element 10 is a steel ball, which has advantages of high hardness, low wear rate, resistance to deformation, and long service life.

The active-passive hybrid control system 100 further includes a holder 11. The number of the rolling element 10 is multiple. The multiple rolling elements 10 are rotatably arranged spaced apart on the holder 11. The first flange 22 is configured to drive the multiple rolling elements 10 to rotate, thereby enabling the multiple rolling elements 10 to drive the holder 11 to rotate. The multiple rolling elements 10 are arranged evenly spaced apart on the holder 11, ensuring each rolling element 10 rolls properly between the first flange 22 and the second flange 912.

In this embodiment, the holder 11 is made of a phenolic laminate tube. Such a holder exhibits high wear resistance and self-lubricating properties, and has advantages of elasticity, plasticity, hardness, impact toughness, fatigue strength, and fracture toughness.

The active-passive hybrid control system 100 also includes a first fixing member 12. The first fixing member 12 is detachably arranged on the base assembly 9. The first motor 3 is provided on the side of the first fixing member 12 away from the base assembly 9.

The active-passive hybrid control system 100 also includes a second fixing member 13. The second fixing member 13 is provided on the side of the first fixing member 12 away from the base assembly 9, with the first motor 3 installed on the side of the second fixing member 13 away from the first fixing member 12.

The bearing is mounted on the mounting plate 911, and the first rotating shaft is connected to the bearing, allowing the first rotating shaft to be rotatably provided on the mounting plate 911.

Working principles of the active-passive hybrid control system for rotational torque are described as follows.

When the to-be-controlled object 7 experiences torsional vibration, the first rotating member 2 initially rotates in the direction opposite to the torsional direction of the to-be-controlled object 7 under the action of the to-be-controlled object 7. This enables the first rotating member 2 to generate torque that can counteract the torsional vibration of the to-be-controlled object 7, which is then transmitted through the elastic reset member 1 to the to-be-controlled object 7, thereby counteracting the torsional vibration of the to-be-controlled object 7. Specifically, during the rotation of the first rotating member 2, the end of the elastic reset member 1 connected to the first rotating member 2 generates a restoring torque in the same direction as the torsional vibration of the to-be-controlled object 7. Since the forces respectively acting on two ends of the elastic reset member 1 are opposite, the end of the elastic reset member 1 connected to the to-be-controlled object 7 produces a torque in the opposite direction to the torsional vibration of the to-be-controlled object 7, that is, the torque at the end of the elastic reset member 1 connected to the to-be-controlled object 7 is opposite to that at the end of the elastic reset member 1 connected to the first rotating member 2, thereby effectively counteracting the torsional vibration. Simultaneously, the sensor 5 detects the torsional angle of the to-be-controlled object 7 and transmits it to the controller 6. The controller 6 processes the received torsional angle and sends corresponding control commands to the first motor 3, which drives the second rotating member 4 to rotate to generate a torque. The torque generated by the second rotating member 4 is transmitted through the first motor 3 to the first rotating member 2, accelerating the rotation of the first rotating member 2. This allows the first rotating member 2 to rapidly produce torque that cancels the torsional vibration of the to-be-controlled object 7, significantly enhancing the control efficiency and precision of the active-passive hybrid control system 100 for rotational torque.

Described above are only preferred embodiments of the present disclosure and are not intended to limit the scope of the present disclosure. Under the inventive concept of this application, all equivalent structural modifications derived from the content of this specification and drawings, or direct/indirect applications in related technical fields, shall fall within the scope of this application defined by the appended claims.

What is claimed is:

1. An active-passive hybrid control system for rotational torque, comprising:
a first rotating shaft;
an elastic reset member;
a first rotating member;
a first motor;
a second rotating member;
a sensor; and
a controller;
wherein the first rotating shaft is rotatably arranged on a to-be-controlled object;
the elastic reset member is sleevedly arranged on the first rotating shaft; the first rotating member is arranged on the first rotating shaft; and a first end of the elastic reset member is connected to the to-be-controlled object, and a second end of the elastic reset member is connected to the first rotating member;
the first motor is provided on a side of the first rotating member away from the first rotating shaft; the second rotating member is arranged on the first motor; the controller is connected to the sensor and the first motor; the first rotating member is configured to rotate in a direction opposite to a torsion direction of the to-be-controlled object under an action of the to-be-controlled object; the sensor is configured to detect a torsion angle of the to-be-controlled object and transmit the torsion angle to the controller; the controller is configured to process the torsion angle to generate a processing result, and output a control command to the first motor based on the processing result, thereby driving the second rotating member to rotate to accelerate a rotation of the first rotating member;
the first rotating member comprises a first rotating plate and a first flange extending radially from an edge of the first rotating plate toward the first motor, and the first flange is annular; the second end of the elastic reset member is connected to the first rotating plate; the first rotating plate is arranged on the first rotating shaft; the first motor is provided on the side of the first rotating plate away from the first rotating shaft; and
the second rotating member comprises a second rotating plate and a second motor;
the second rotating plate is arranged on the first motor; the second motor is provided on a side of the second rotating plate away from the first motor; the second motor is in transmission connection with an inner wall of the first flange; and the controller is further configured to control the second motor to accelerate a rotation of the first flange based on the processing result, thereby making the first flange drive the first rotating plate to rotate.

2. The active-passive hybrid control system of claim 1, further comprising:
a transmission assembly;
wherein the second motor and the first flange are in transmission connection through the transmission assembly.

3. The active-passive hybrid control system of claim 2, wherein the transmission assembly comprises a gear; the second motor is provided with a second rotating shaft; the gear is sleevedly arranged on the second rotating shaft; the inner wall of the first flange is provided with a toothed ring; and the gear is engaged with the first flange through the toothed ring for transmission.

4. The active-passive hybrid control system of claim 3, wherein a plurality of second motors and a plurality of gears are provided; the plurality of second motors are arranged on the side of the second rotating plate away from the first motor; and the plurality of gears are arranged on second rotating shafts of the plurality of second motors in one-to-one correspondence.

5. The active-passive hybrid control system of claim 1, further comprising:
a base assembly;
wherein the base assembly is configured to be mounted within the to-be-controlled object; the first rotating shaft is rotatably mounted on the base assembly; and the first end of the elastic reset member is connected to the base assembly.

6. The active-passive hybrid control system of claim 5, wherein the base assembly comprises a mounting seat and a connecting arm arranged on the mounting seat; an end of the connecting arm away from the mounting seat is connected to an inner wall of the to-be-controlled object; the first rotating shaft is rotatably arranged on the mounting seat; and the first end of the elastic reset member is connected to the mounting seat.

7. The active-passive hybrid control system of claim 6, wherein the mounting seat comprises a mounting plate and a second flange extending radially from an edge of the mounting plate toward the first rotating shaft, and the second flange is annular; the first rotating shaft is rotatably arranged on the mounting plate; the first end of the elastic reset member is connected to the mounting plate; the connecting arm is provided on an outer wall of the second flange; and an outer wall of the first flange is rotatable along an inner wall of the second flange.

8. The active-passive hybrid control system of claim 7, further comprising:
a rolling element;
wherein the rolling element is provided between the first flange and the second flange; and
the outer wall of the first flange is provided with a first raceway; the inner wall of the second flange is provided with a second raceway corresponding to the first raceway;
the rolling element is rollable within a cavity formed by the first raceway and the second raceway, so as to enable the outer wall of the first flange to rotate along the inner wall of the second flange.

9. The active-passive hybrid control system of claim 8, further comprising:
a holder;
wherein a plurality of rolling elements are provided; the plurality of rolling elements are rotatably arranged spaced apart on the holder; and the first flange is configured to drive the plurality of rolling elements to rotate, so as to drive the holder to rotate.
